(19) United States
(12) Patent Application Publication
(10) Pub. No.: US 2009/0218957 A1
(43) Pub. Date: Sep. 3, 2009

(54) METHODS, APPARATUSES, AND COMPUTER PROGRAM PRODUCTS FOR CONSERVING POWER IN MOBILE DEVICES

(75) Inventors: Christian Rossing Kraft, Frederiksberg C (DK); Peter Dam Nielsen, Lyngby (DK); Jacob Hansen, Naestved (DK); Steffen Kramer Valsted, Frederiksberg (DK); Mikko Kalervo Makela, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 12/039,924

(22) Filed: Feb. 29, 2008

(51) Int. Cl. H05B 41/36; G06F 1/32

(52) U.S. Cl. 315/291; 713/320

(57) ABSTRACT

An apparatus for conserving power in mobile devices may include a processor. The processor may be configured to determine whether a condition has been satisfied and alter a state of one or more functionalities of a device if the condition has been satisfied while leaving the state of one or more other functionalities of the device unaltered. Corresponding methods, and computer program products are also provided.

### TECHNOLOGICAL FIELD

Embodiments of the present invention relate generally to mobile communication technology and, more particularly, relate to methods, apparatuses, and computer program products for conserving power in mobile devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

This explosive growth of mobile communications networks has followed the evolution of mobile devices, such as cellular phones, personal digital assistants (PDAs), and other portable electronic devices from luxury items to ubiquitous devices integrated into the everyday lives of individuals from all walks of life. The widespread adoption of mobile devices and expanding capabilities of the wireless networks over which they communicate has allowed for a tremendous expansion in the functionalities which mobile devices are capable of executing. In addition to providing for phone service, many mobile devices now execute functionalities such as navigation services through the use of GPS, camera and video capturing capabilities, digital music and video playback, and web browsing.

While this expansion in functionality of mobile devices has been revolutionary, it does have a drawback in that each added functionality requires additional power to execute and in some cases, the power consumption of some functionalities, such as a camera with a flash or GPS receiver may be quite substantial. This increased power consumption may present a problem to users of mobile devices by rapidly draining mobile device batteries as power storage capacity of batteries has remained essentially constant in comparison to the exponential growth in the capabilities of mobile devices. Draining of mobile device batteries may be particularly troublesome for device users in situations where the user is traveling or otherwise is not in close proximity to an alternative power source to charge or otherwise power the mobile device battery. These additional functionalities may drain battery power to the point where a mobile device is not even capable of executing a simple phone call. Thus, as a result, utilization of these additional power-consuming functionalities may leave a user with a powerful mobile device, but no power to operate any functionalities of the device.

In some instances in which multiple functionalities with high power requirements are executing concurrently, an amount of current may be drawn from the battery that is sufficient to cause voltage to decrease. In extreme cases, current consumption may cause voltage to drop below a cut-off value, which may effectively turn the device off. Further problems may be generated from drawing a large amount of current in that the more current that is drawn from a battery, the more heat is generated. In extreme cases, this generated heat may damage electronic components of the device or may cause discomfort to a device user.

Furthermore, power consumption by mobile devices may impact the environment. Energy required to charge mobile device batteries may result in pollution, such as from being produced by fossil fuels, as well as depletion of non-renewable energy resources. Furthermore, disposal of spent mobile device batteries, which may contain toxic compounds may also result in problematic environmental impact.

Accordingly, it would be advantageous to provide methods, apparatuses, and computer program products that provide for reduced or otherwise managed power consumption within mobile devices and as such prolong mobile device battery life.

### BRIEF SUMMARY

A method, apparatus, and computer program product are therefore provided to improve the experience of mobile device users. In particular, a method, apparatus, and computer program product are provided to intelligently enable the conservation of power in mobile devices based upon a current state associated with the device or other predefined condition. Accordingly, users of mobile devices may experience greater battery life in their mobile devices and may save money and/or reap other benefits from using less power.

In one exemplary embodiment, a method is provided which may comprise determining whether a condition has been satisfied and altering a state of one or more functionalities of a device if the condition has been satisfied while leaving the state of one or more other functionalities of the device unaltered. Determining whether a condition has been satisfied may comprise one or more of determining whether a predetermined point in time has been reached, determining whether a predetermined length of time has passed, determining whether one or more functionalities of the device are currently in use, determining power remaining in a battery associated with the device, or determining whether the device is connected to an external power source. Altering a state of one or more functionalities of a device if the condition has been satisfied while leaving the state of one or more other functionalities of the device unaltered may comprise one or more of disabling one or more functionalities of the device, enabling one or more functionalities of the device, altering a volume level associated with one or more functionalities of the device, or altering an illumination associated with one or more functionalities of the device.

In another exemplary embodiment, a computer program product is provided, which includes at least one computer-readable storage medium having computer-readable program code portions stored therein. The computer-readable program code portions include first and second executable portions. The first executable portion is for determining whether a condition has been satisfied. The second executable portion is for altering a state of one or more functionalities of a device if the condition has been satisfied while leaving the state of one or more other functionalities of the device unaltered.

In another exemplary embodiment, an apparatus is provided which may include a processor. The processor may be configured to determine whether a condition has been satisfied and alter a state of one or more functionalities of a device if the condition has been satisfied while leaving the state of one or more other functionalities of the device unaltered.

In another exemplary embodiment, a method is provided which may comprise illuminating at least a portion of a device, monitoring motion of the device, and altering the illumination of at least a portion of the device based upon the monitoring of motion of the device. Monitoring motion of the device may comprise receiving an indication of a state of motion of the device from one or more of a GPS receiver associated with the device, a motion sensor associated with the device, an accelerometer associated with the device, or a pedometer associated with the device. Altering the illumination of at least a portion of the device based upon the motion of the device may comprise one or more of altering a length of time during which the portion of the device is illuminated or altering a brightness of the illumination.

In another exemplary embodiment, a computer program product is provided, which includes at least one computer-readable storage medium having computer-readable program code portions stored therein. The computer-readable program code portions include first, second, and third executable portions. The first executable portion is for illuminating at least a portion of a device. The second executable portion is for monitoring motion of the device. The third executable portion is for altering the illumination of at least a portion of the device based upon the monitoring of motion of the device.

Embodiments of the invention may therefore provide a method, apparatus, and computer program product for conserving power in mobile devices. As such, mobile device users may benefit from greater battery life of batteries associated with their mobile devices.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a flowchart illustrating a method for conserving power in mobile devices in accordance with one embodiment of the present invention; and

FIG. 3 is a flowchart illustrating another method for conserving power in mobile devices in accordance with one embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

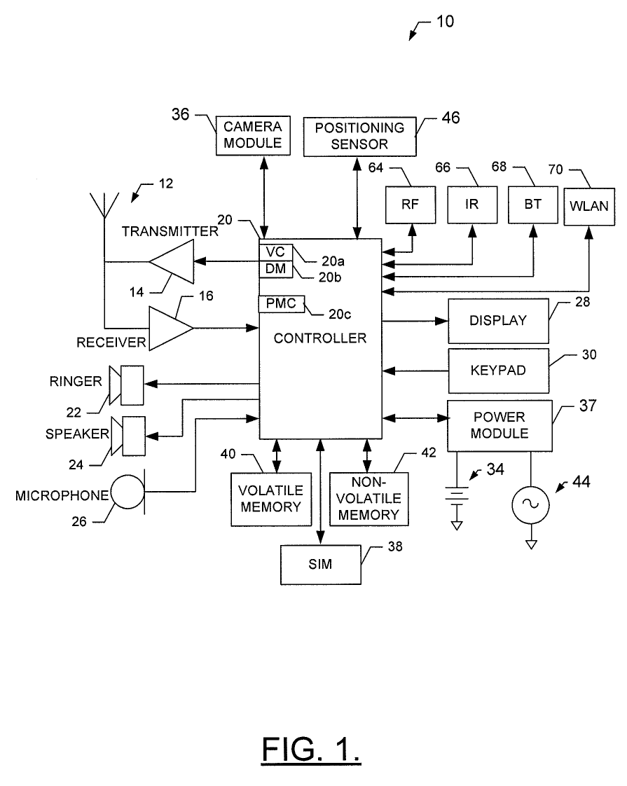

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from the present invention and, therefore, should not be taken to limit the scope of the present invention. While several embodiments of the electronic device are illustrated and will be hereinafter described for purposes of example, other types of electronic devices, such as portable digital assistants (PDAs), pagers, laptop computers, desktop computers, gaming devices, televisions, and other types of electronic systems, may employ embodiments of the present invention.

As shown, the mobile terminal 10 may include an antenna 12 in communication with a transmitter 14, and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be configured to operate in accordance with 3G wireless communication protocols such as UMTS network employing WCDMA radio access technology. Some NAMPS, as well as TACS, mobile terminals may also benefit from the teaching of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry required for implementing audio and logic functions of the mobile terminal 10. For example, the controller 20 may be a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50. The controller 20 may additionally comprise a power management controller (PMC) 20C, described more fully below, which may manage and monitor power use in the mobile terminal 10 and selectively enable and disable functionalities of the mobile terminal according to power states or other predefined criteria within the device.

The mobile terminal 10 may also comprise a user interface including a conventional earphone or speaker 24, a ringer 22, a microphone 26, a display 28, a user input interface, and/or the like, which may be coupled to the controller 20. The mobile terminal may comprise a battery 34 for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

In an exemplary embodiment, mobile terminal 10 may further comprise a power module 37, in communication with the PMC 20c of controller 20. As used herein, the term “exemplary” merely refers to an example and should not be construed to refer to a “preferred” embodiment. The power module 37 may be any means, hardware or software, for delivering power to mobile terminal 10. In some embodiments, power module 37 may be a software implementation controlled by a processor, such as, for example, controller 20 of mobile terminal 10. As such, the power module 37 may include all hardware, and software necessary for delivering power to mobile terminal 10. Alternatively, in some embodiments, power module 37 may include only the hardware needed to provide for the use of supplemental power source 44 by mobile terminal 10. Supplemental power source 44 may be an adapter permitting the connection of mobile terminal 10 to an alternative power source, such as an AC power source or a vehicle battery. The alternative power source may be used to power mobile terminal 10 as well as to charge the battery 34. In an exemplary embodiment, power module 37 may further monitor the power level remaining in the battery 34 and communicate the status of the battery life of battery 34 to the PMC 20c. An indication of the battery life status may further be displayed to a user of the mobile terminal via display 28.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal 10 may further include a WLAN transceiver 70 capable of transmitting and/or receiving data from electronic devices according various wireless networking techniques, including Wireless Fidelity (Wi-Fi), WLAN techniques such as IEEE 802.11 techniques, and/or the like.

In an exemplary embodiment, the mobile terminal 10 may include a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. In addition, the digital camera of the camera module 36 may be capable of capturing a video clip. As such, the camera module 36 may include all hardware, such as a lens or other optical component(s), and software necessary for creating a digital image file from a captured image as well as a digital video file from a captured video clip. Alternatively, the camera module 36 may include only the hardware needed to view an image, while a memory device of the mobile terminal 10 stores instructions for execution by the controller 20 in the form of software necessary to create a digital image file from a captured image. As yet another alternative, an object or objects within a field of view of the camera module 36 may be displayed on the display 28 of the mobile terminal 10 to illustrate a view of an image currently displayed which could be captured if desired by the user. As such, as referred to hereinafter, an image could be either a captured image or an image comprising the object or objects currently displayed by the mobile terminal 10, but not necessarily captured in an image file. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard, a moving picture experts group (MPEG) standard, or other format.

The mobile terminal 10 may include a positioning sensor 46. The positioning sensor 46 may include, for example, a global positioning system (GPS) sensor, an assisted global positioning system (Assisted-GPS) sensor, etc. In one embodiment, however, the positioning sensor includes a pedometer or inertial sensor. Further, the positioning sensor may determine the location of the mobile terminal based upon signal triangulation or other mechanisms. The positioning sensor may be configured to determine a location of the mobile terminal, such as latitude and longitude coordinates of the mobile terminal or a position relative to a reference point such as a destination or a start point. Information from the positioning sensor may be communicated to a memory of the mobile terminal or to another memory device to be stored as a position history or location information. Furthermore, the memory of the mobile terminal may store instructions for determining cell id information. In this regard, the memory may store an application program for execution by the controller 20, which determines an identity of the current cell, i.e., cell id identity or cell id information, with which the mobile terminal is in communication. In conjunction with the positioning sensor, the cell id information may be used to more accurately determine a location of the mobile terminal. In an exemplary embodiment, the positioning sensor 46 may comprise an accelerometer and/or pedometer, which may be used in obtaining a position fix for the mobile terminal 10 or to determine a state of motion of the mobile terminal 10. In embodiments where the positioning sensor comprises a GPS sensor or the like, a state of motion of the mobile terminal 10 may also be determined. In this regard, the positioning sensor may be configured to determine whether the mobile terminal 10 is in motion based upon whether the location of the mobile terminal 10 is changing over an interval 10. In exemplary embodiments, the positioning sensor may be configured to determine a degree or severity of this state of motion based upon, for example, the distance traveled by the mobile terminal 10 over a time interval.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

In an exemplary embodiment, the PMC 20c may be configured to execute algorithms or other software that selectively enables or disables functionalities of a mobile terminal 10 in response to certain predefined conditions occurring. As used herein, the term “functionalities” is to be construed as encompassing hardware modules, such as, for example, the camera module 36 and positioning sensor 46 as well as software applications and other software routines which may be executed by or otherwise controlled by the controller 20, such as audio or video player applications, web browsers, and e-mail programs.

In one exemplary embodiment, a user may enter time-based parameters for when functionalities of the mobile terminal 10 are to be automatically enabled and disabled, such as through a user interface using the keypad 30. In this regard, a user may, for example, configure the PMC 20c to disable certain functionalities, such as WLAN, GPS, or BT, beginning at 11:00 PM every night and then to enable them at 7:00 AM every morning. As such, a user may define periods when he or she does not anticipate using certain power draining functionalities of the mobile terminal 10 so that the PMC 20c will disable the specified functionalities during those time periods and reduce power usage by the mobile terminal 10. Other functionalities of the phone may remain enabled during the defined period. In another scenario, a user may configure the PMC 20c to disable certain functionalities of mobile terminal 10 on certain days of the week. For example, if a user uses the positioning sensor 46 frequently during the workweek for navigational purposes, but rarely uses positioning sensor 46 during weekends when not working, the user may configure the PMC 20c to disable the positioning sensor 46 on Saturday and Sunday so as to conserve power. The user-defined functionalities to be selectively enabled and disabled may be stored as a list in memory, such as non-volatile memory 42 in association with the time periods during which the respective functionalities are to be disabled. As such, the PMC 20c may be configured to execute or otherwise control a software application that determines when user-specified conditions stored in memory are met and if they have been met to alter a state of one or more functionalities, wherein altering a state means to selectively enable or disable the one or more functionalities or to otherwise alter a characteristic of a functionality based upon the user configurations.

In another exemplary embodiment, the PMC 20c may be configured to selectively enable or disable one or more functionalities based upon whether the functionalities are currently in use. In this regard, a “timeout” period may be defined, such as if a functionality has not been used for a predefined period of time, the functionality will be disabled so as to conserve power. For example, if no web browsing or other internet communication has been executed on the mobile terminal 10 for a predefined timeout period, the WLAN communications module 70 may be disabled to conserve power. Subsequent activation of the disabled functionalities may occur periodically, such as after a predefined “sleep” period. In this regard, the PMC 20c may enable a disabled functionality following the sleep period and if it is not actively used before the expiration of the timeout period, the PMC 20c may again disable the functionality. In another embodiment, subsequent activation may not occur until a user opens an application executed on the mobile terminal 10 or engages in some other activity that requires the use of the disabled functionality. In an alternative exemplary embodiment, rather than automatically disabling a functionality after the expiration of a timeout period, the PMC 20c may be configured to provide a graphical or audible indication to a user of the mobile terminal 10, such as via the display 28 or speaker 24 alerting the user that a functionality is not in active use and may be disabled to conserve power. A user may then respond with an indication instructing the PMC 20c to proceed with disabling the functionality or to allow the functionality to remain enabled. If a user does not respond to the query within a predefined period, the PMC 20c may be configured to disable the functionality without user authorization.

In another embodiment, the PMC 20c may be configured to selectively enable or disable certain functionalities depending on whether an external power source, such as alternative power source 44, is connected to the mobile terminal 10. In this regard, the PMC 20c may be in communication with the power module 37 and receive an indication of whether or not an alternative power source 44 is currently connected to the mobile terminal 10. Thus, for example, if a functionality such as the positioning sensor 46 consumes power at a rate that would quickly drain the battery 34 in the absence of an alternative power source 44, the PMC 20c may only enable the positioning sensor when an alternative power source 44 is connected. While in exemplary embodiments, the PMC 20c may be preconfigured to disable certain functionalities in the absence of an alternative power source 44, embodiments of the present invention are not so limited and a user may enter settings, such as via the user interface, to be stored in non-volatile memory 42 which define which functionalities that should be selectively enabled or disabled in response to whether or not an alternative power source 44 is connected to the mobile terminal 10. It will be appreciated, however, that in some embodiments a user may override the default configuration of PMC 20c by, for example, activating a functionality even in the absence of an external power source. In another embodiment, the PMC 20c may be configured to selectively disable one or more functionalities in response of the connection of an alternative power source 44 to the mobile terminal 10. As such, the PMC 20c may disable functionalities that are generally not used by a user while charging the battery 34 of the mobile terminal 10 so as to conserve power and allow for the more rapid charging of the battery 34 by the alternative power source 44.

In an exemplary embodiment, the PMC 20c may be further configured to selectively disable one or more functionalities while leaving the state of one or more other functionalities unchanged depending on the level of power (battery life) remaining in the battery 34. In this regard, the PMC 20c may be in communication with the power module 37 and receive an indication of the current power level in the battery 34. As such, there may be a list of functionalities to disable in response to the power level remaining in the battery 34 reaching a predefined “critical” level stored in memory 42. Additionally, or alternatively, exemplary embodiments may have a predefined listing of ranges, increments, or “baskets” of power level remaining, which may, for example, be stored in non-volatile memory 42. These ranges may, for example, be defined as 10% increments, such as 100-91% power remaining, 90%-81% power remaining, etc. As such, a prioritized listing of functionalities may also be defined and stored in memory, such as non-volatile memory 42. These functionalities may be prioritized in the order in which they should be disabled so as to conserve power so that functionalities considered to be of critical importance to a user of mobile terminal 10, such as sending or receiving a phone call may still be executed. For example, the listing may be prioritized so that the PMC 20c is configured to disable the positioning sensor 46 when the power remaining reaches 40%, the camera module 36 when the power remaining reaches 30%, the BT 68 and WLAN 70 communication modules when power remaining reaches 20%, and all other non-critical functionalities, such as audio and video players, when the power remaining reaches 10%. Additionally, or alternatively, the PMC 20c may be configured to reduce power consumption by other means in response to battery life levels, such as by decreasing audio volume, decreasing display brightness, or other similar means of decreasing power consumption.

In an exemplary embodiment, the PMC 20c may be in communication with the positioning sensor 46 and as such may receive an indication of any motion of the mobile terminal 10 from the positioning sensor 46, which may be configured to monitor the motion thereof. Such an indication may simply be an indication of whether the mobile terminal 10 is in motion or not, or may be an indication of the severity of motion of the mobile terminal 10 or other means of indicating a graduated degree of instability or motion of the mobile terminal 10. In such embodiments, the PMC 20c may be configured to control a means of illumination of at least a portion of the mobile terminal 10, such as a backlight of the display 28 and/or a backlight of the keypad 30, in response to the indication of motion received from the positioning sensor 46. For example, the PMC 20c may be configured to illuminate a backlight of the display 28 for one predefined timeout period if the device is not in motion and a longer predefined timeout period if the device is in motion. In this regard, a user of a mobile terminal 10, which is not stable, i.e. moving, and as such may have a harder time reading text or other information displayed on the display 28 will have the aid of the backlight being illuminated for a longer period of time than a user of a mobile terminal 10, which is stable, i.e. not moving, and as such may not require as much time to view the display 28. In embodiments in which the positioning sensor 46 determines a degree or severity of instability or motion, such as, for example, the distance of a change in position over a given time interval, the timeout period for the backlight of the display 28 may comprise a series of predefined timeouts varying according to the severity of motion or instability. Thus, the greater the severity of motion or instability of the mobile terminal 10, the longer the timeout period for the light illumination may be. In this regard, a power consuming functionality, such as a backlight designed to illuminate a portion of a mobile terminal 10 to allow a user to better read the display 28 or otherwise interact with the mobile terminal 10 is enabled only so long as needed and thus power may be conserved.

While the PMC 20c has been primarily described hereinabove to control the illumination of a portion of the mobile terminal 10 by controlling the length of time that the portion of the mobile terminal is illuminated based upon the motion of the mobile terminal, the PMC 20c can additionally or alternatively control other characteristics of the illumination based upon the motion of the mobile terminal. For example, the PMC 20c can control the intensity of illumination based upon the motion of the mobile terminal, such as by providing more intense illumination of the display 28 and/or the keypad 30, in instances in which the positioning sensor 46 determines the mobile terminal to be in motion. As before, the PMC 20c can further increase the intensity of illumination in instances in which the mobile terminal is determined to not only be in motion, but to be undergoing motion having a severity that exceeds a predefined threshold. By selectively providing increased illumination, a user of a mobile terminal that is in motion may have a better opportunity to interact with the mobile terminal, while conserving power by providing reduced levels of illumination, if any, in instances in which the mobile terminal is stationary or is moving at a slow rate, such a below a predefined threshold.

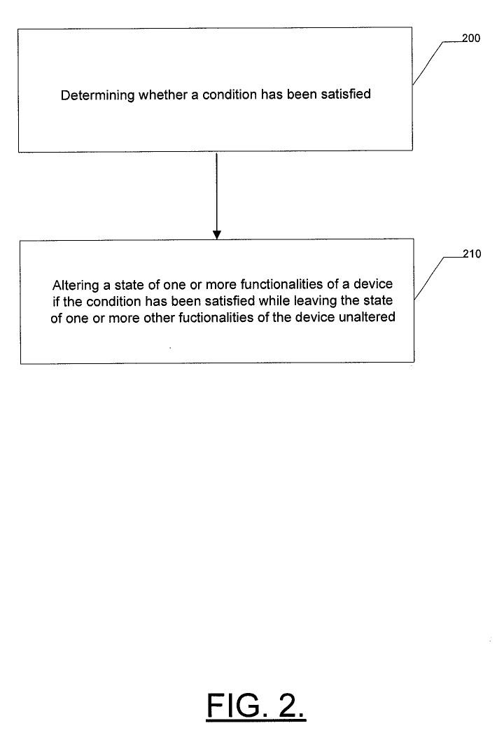

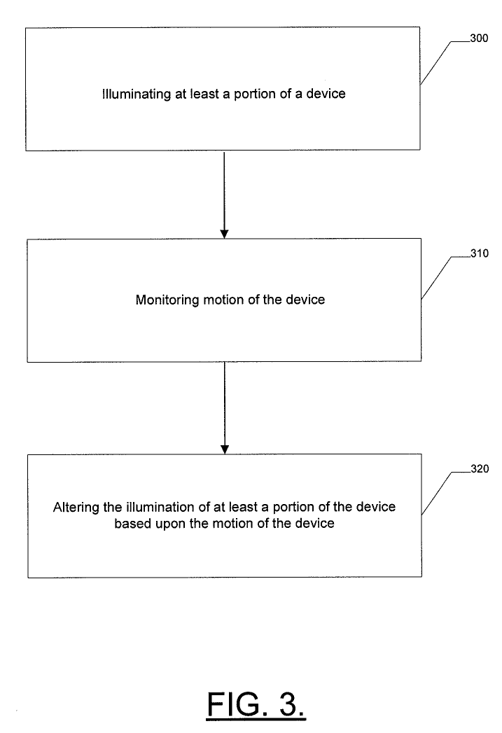

FIGS. 2 and 3 are flowcharts of methods and computer program products according to an exemplary embodiment of the invention. It will be understood that each block or step of the flowcharts, and combinations of blocks in the flowcharts may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a processor of a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the block(s) or step(s) of the flowcharts.

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, may be implemented by special purpose hardware-based computer systems which perform the specified functions or steps, or combinations of special purpose hardware and computer instructions.

In this regard, one embodiment of a method for conserving power in a mobile device as depicted in FIG. 2 may include determining whether a condition has been satisfied, at operation 200. As discussed above, the determination step may be performed by or otherwise controlled by the PMC 20c and the condition may be a user specified condition or other predefined condition upon which the PMC 20c is configured to take action. Next, at operation 210, a hardware or software component, such as, for example, the PMC 20c may alter a state of one or more functionalities of a device if the condition has been satisfied while leaving the state of one or more other functionalities of the device unaltered. As used herein, a “state” of a functionality may refer to whether the functionality is enabled (activated) or disabled (deactivated) as well as characteristics of a functionality, such as a volume associated with the functionality (such as a volume at which audio is played back over the speaker 24 by an audio player) or an illumination level associated with a functionality (such as the brightness or length of illumination of the display 28).

Referring now to FIG. 3, a flowchart according to an exemplary method for conserving power in mobile devices based upon the movement of the device is illustrated. The method may comprise illuminating at least a portion of a device, at operation 300. Next, at operation 310, the PMC 20c, positioning sensor 46, or some combination thereof may monitor motion of the device. The PMC 20c may then, at operation 320, alter the illumination of at least a portion of the device based upon the motion of the device.

The above described functions may be carried out in many ways. For example, any suitable means for carrying out each of the functions described above may be employed to carry out embodiments of the invention. In one embodiment, all or a portion of the elements generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, embodiments of the invention provide several advantages for mobile device users who may use their mobile devices for a variety of tasks important to their everyday lives. These tasks, or functionalities, which a mobile device is capable of executing may consume a significant amount of power in situations wherein there is a limited level of power in a battery of the device or where it is otherwise desirable to conserve power. Embodiments of the invention provide several ways in which power consumption in mobile devices may be intelligently reduced.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
determining whether a condition has been satisfied; and
altering a state of one or more functionalities of a device if the condition has been satisfied while leaving the state of one or more other functionalities of the device unaltered.

2. The method of claim 1, wherein determining whether a condition has been satisfied comprises one or more of:
determining whether a predetermined point in time has been reached;
determining whether a predetermined length of time has passed;
determining whether one or more functionalities of the device are currently in use;
determining power remaining in a battery associated with the device; or
determining whether the device is connected to an external power source.

3. The method of claim 1, wherein altering a state of one or more functionalities of a device if the condition has been satisfied while leaving the state of one or more other functionalities of the device unaltered comprises one or more of:
disabling one or more functionalities of the device;
enabling one or more functionalities of the device;
altering a volume level associated with one or more functionalities of the device; or
altering an illumination associated with one or more functionalities of the device.

4. The method of claim 1, wherein determining whether a condition has been satisfied comprises monitoring a power level remaining in a battery associated with the device and comparing the power level remaining to one or more predefined ranges of power levels.

5. The method of claim 4, wherein altering a state of one or more other functionalities of a device if the condition has been satisfied while leaving the state of one or more functionalities of the device unaltered comprises disabling one or more functionalities of the device according to a predefined prioritized listing of functionalities that are to be disabled when remaining battery life falls within a predefined range of power levels.

6. A computer program product comprising at least one computer-readable storage medium having computer-readable program code portions stored therein, the computer-readable program code portions comprising:
a first executable portion for determining whether a condition has been satisfied; and
a second executable portion for altering a state of one or more functionalities of a device if the condition has been satisfied while leaving the state of one or more other functionalities of the device unaltered.

7. The computer program product of claim 6, wherein the first executable portion includes instructions for determining whether a condition has been satisfied by one or more of:
determining whether a predetermined point in time has been reached;
determining whether a predetermined length of time has passed;
determining whether one or more functionalities of the device are currently in use;
determining power remaining in a battery associated with the device; or
determining whether the device is connected to an external power source.

8. The computer program product of claim 6, wherein the second executable portion includes instructions for altering a state of one or more functionalities of a device if the condition has been satisfied while leaving the state of one or more other functionalities of the device unaltered by one or more of:
disabling one or more functionalities of the device;
enabling one or more functionalities of the device;
altering a volume level associated with one or more functionalities of the device; or
altering an illumination associated with one or more functionalities of the device.

9. The computer program product of claim 6, wherein the first executable portion includes instructions for determining whether a condition has been satisfied by monitoring a power level remaining in a battery associated with the device and comparing the power level remaining to one or more predefined ranges of power levels.

10. The computer program product of claim 9, wherein the second executable portion includes instructions for altering a state of one or more other functionalities of a device if the condition has been satisfied while leaving the state of one or more functionalities of the device unaltered by disabling one or more functionalities of the device according to a predefined prioritized listing of functionalities that are to be disabled when remaining battery life falls within a predefined range of power levels.

11. An apparatus comprising a processing element configured to:
determine whether a condition has been satisfied; and
alter a state of one or more functionalities of a device if the condition has been satisfied while leaving the state of one or more other functionalities of the device unaltered.

12. The apparatus of claim 11, wherein the processing element is further configured to determining whether a condition has been satisfied by one or more of:
determining whether a predetermined point in time has been reached;
determining whether a predetermined length of time has passed;
determining whether one or more functionalities of the device are currently in use;
determining power remaining in a battery associated with the device; or
determining whether the device is connected to an external power source.

13. The apparatus of claim 11, wherein the processing element is further configured to alter a state of one or more functionalities of a device if the condition has been satisfied while leaving the state of one or more other functionalities of the device unaltered by one or more of:
disabling one or more functionalities of the device;
enabling one or more functionalities of the device;
altering a volume level associated with one or more functionalities of the device; or
altering an illumination associated with one or more functionalities of the device.

14. The apparatus of claim 11, wherein the processing element is further configured to determine whether a condition has been satisfied by monitoring a power level remaining in a battery associated with the device and comparing the power level remaining to one or more predefined ranges of power levels.

15. The apparatus of claim 14, wherein the processing element is further configured to alter a state of one or more other functionalities of a device if the condition has been satisfied while leaving the state of one or more functionalities of the device unaltered by disabling one or more functionalities of the device according to a predefined prioritized listing of functionalities that are to be disabled when remaining battery life falls within a predefined range of power levels.

16. A method comprising:
illuminating at least a portion of a device;
monitoring motion of the device; and
altering the illumination of at least a portion of the device based upon the motion of the device.

17. The method of claim 16, wherein altering the illumination of at least a portion of the device based upon the motion of the device comprises one or more of altering a length of time during which the portion of the device is illuminated or altering a brightness of the illumination.

18. The method of claim 16, wherein monitoring motion of the device comprises receiving an indication of a state of motion of the device from one or more of a GPS receiver associated with the device, a motion sensor associated with the device, an accelerometer associated with the device, or a pedometer associated with the device.

19. A computer program product comprising at least one computer-readable storage medium having computer-readable program code portions stored therein, the computer-readable program code portions comprising:
a first executable portion for illuminating at least a portion of a device;
a second executable portion for monitoring motion of the device; and
a third executable portion for altering the illumination of at least a portion of the device based upon the motion of the device.

20. The computer program product of claim 19, wherein the third executable portion includes instructions for altering the illumination of at least a portion of the device based upon the motion of the device by one or more of altering a length of time during which the portion of the device is illuminated or altering a brightness of the illumination.

21. The computer program product of claim 19, wherein the second executable portion includes instructions for monitoring motion of the device by receiving an indication of a state of motion of the device from one or more of a GPS receiver associated with the device, a motion sensor associated with the device, an accelerometer associated with the device, or a pedometer associated with the device.
